(19) United States
(12) Patent Application Publication
(10) Pub. No.: US 2013/0174121 A1
(43) Pub. Date: Jul. 4, 2013

(54) Automated Run Time Embedding of Software Snippets (ARTESS) system and method for improving the software and the software testing.

(71) Applicant: Michael Pindrik, Baltimore, MD (US)

(72) Inventor: Michael Pindrik, Baltimore, MD (US)

(21) Appl. No.: 13/340,320

(22) Filed: Dec. 29, 2011

(51) Int. Cl. G06F 9/44; G06F 11/36

(52) U.S. Cl. 717/120

(57) ABSTRACT

The Automated Run Time Embedding of Software Snippets (ARTESS) system and method comprise of a pick-and-choose multi-phase integrated process for automated profiling and execution of software modules in test environment for the purpose of verification of the software functional stability throughout the software life cycle. Additionally, ARTESS method and system are suitable for upgrade, in automated way, of application-specific software modules with improvements to error-handling code. The presented ARTESS method is deployable for software systems constructed in languages that allow run-time source code modifications.

### BACKGROUND

The present invention relates to systems and methods that provide improvements in automated software development and in automated software testing. Proposed system and method provide substantial efficiencies in software development and validation of the functionality and performance of software applications. In many instances only some steps (out of the available complete set of steps) are needed to obtain benefits in development and testing of software applications.

The presented ARTESS system and method expand the variety of standard automated development and testing tools. The presented ARTESS system and method are designed to dramatically reduce time and cost needed to build reliable software applications.

### Definitions

‘Application Specific Database’—any Microsoft TSQL database containing tables and software developed for a specific application and subjected to upgraded during a regular software improvement life cycle.

ARTESS (Automated Run-Time Embedding of Software Snippets)—Microsoft TSQL software, described in this patent application, developed for the purpose of more efficient and reliable testing of ‘Application Specific Database’ data and software. ARTESS software gets installed in the ‘Application Specific Database’ itself.

‘Controlled Functional Test’—any functional test that exercises designated application specific functionality and has known start and end time values.

ARTESS Profiling—embedding of profiling Software Snippets into application-specific stored procedures together with generating of profiling triggers, followed by profiling data collection during the run-time of said application-specific stored procedures.

‘ARTESS Controlled Functional Test’—‘Controlled Functional Test’ where all stored procedures executed during said ‘Controlled Functional Test’ and all permanent tables modified during said ‘Controlled Functional Test’ are subjected to ARTESS Profiling.

ARTESS-Designated Stored procedure—application-specific stored procedures selected to be profiled prior to start of some ‘ARTESS Controlled Functional Test’. If it is not known at the start of the ARTESS End-to-End Test which Store Procedures will be executed during the ‘Controlled Functional Test’, all application-specific stored procedures residing in ‘Application Specific Database’ may be considered as ‘designated’, thus guaranteeing that all stored procedures and tables participating in ‘Controlled Functional Test’ are subjected to ARTESS Profiling.

‘Stand-Alone Execution of a Stored Procedure’—execution of the dynamic SQL statement: “EXEC <procedure name><restored parameter values>”.

‘Test-Bed Execution of a Stored Procedure’—repetitive restoration of the database values followed by ‘Stand-Alone Execution of a Stored Procedure’.

‘Replaying a Store Procedures’—repetitive restoration of the database and ‘Stand-Alone Execution of a Stored Procedure’.

‘Functionally-Relevant Results’—results of execution of a functionally-specific stored procedure, excluding values constituting audit-specific values of GETDATE( )function, TIMESTAMPS.

‘Identical Functionally-Relevant Results’—‘Functionally-Relevant Results’ excluding values derived from random number generators.

### DETAILED DESCRIPTION

The Microsoft TSQL-based ARTESS (Automated Run-Time Embedding of Software Snippets) system is an integrated end-to-end system for improving software testing of Microsoft TSQL-based application databases. ARTESS system comprises of:

a. Embedding Software snippets into application-specific stored procedures causing no effect on the application-specific functionality.

b. Control Functional Test execution on software containing embedded Software snippets.

c. Collection and utilization of profiled data obtained during the Controlled Functional Test.

d. Reversal of database changes that occurred during the Controlled Functional Test.

e. Test-bed execution of designated application-specific Microsoft TSQL Stored procedures with functionally-relevant results identical to, or predetermined from, results observed during the Controlled Functional Test.

Deployment of Microsoft TSQL-based ARTESS (Automated Run-Time Embedding of Software Snippets) system consists of the following steps:

Step 1. Generate and save in ARTESS-specific backup, in automated way, designated application-specific Stored Procedures with Software Snippets embedded in these application-specific Stored Procedures. NOTE: this step by itself, with minor modification, is sufficient to upgrad application-specific Stored Procedures with BEGIN TRY . . . END TRY BEGIN CATCH . . . END CATCH statements for the purpose of creating a system-wide complete, defect-free and uniform error handling software.

Step 2. In automated way, replace in SYSCOMMENTS all designated Application Stored Procedures with Application Stored Procedures containing embedded Software Snippets.

Step 3. In automated way, generate designated permanent tables profiles and new permanent Tables' triggers that collect and record to ARTESS-specific tables all changes that occur in application-specific tables during the Controlled Functional Test.

Step 4. Conduct Controlled Functional Test, manually or automated.

Step 5. In automated way, reverse database changes that occurred during the Controlled Functional Test. This step is accomplished by reverse-applying all the changes made in the database (and profiled by ARTESS triggers) in the order opposite to the chronological order of changes made during the Controlled Functional Test. NOTE: this step may be accomplished with 100% accuracy only if each ‘under test permanent database table’ contains IDENTITY and/or TIMESTAMP columns or each row in each ‘under test permanent database table’ contains unique set of values.

Step 6. In automated way, install in SYSCOMMENTS application-specific Stored Procedures that contain embedded code where ROLLBACKs are replaced by COMMITs and BEGIN CATCH contain embedded code snippets that just re-throw the error. This provides the ability to have, during replay in test-bed environment, full control over error handling in the ‘under test stored procedure’.

Step 7. In automated way, delete and reinstall, in SYSCOMMENTS, INSERT and DELETE triggers with newly embedded code that converts plain Insert operations into IDENTITY Insert operations, thus providing the ability to replay the application-specific stored procedure with functionally-relevant results identical to, or close to identical to, the results obtained during the Controlled Functional Test.

Step 8. In automated way, for each application-specific stored procedure determine the structure of Temporary Table needed to accept the values outputted by SELECT statements during execution of the said application-specific stored procedure.

Step 9. In a stand-alone mode and in automated way, replay all the Controlled Functional Test stored procedures in a chronological order.

Step 10. In automated way, generate a report comparing results obtained during multiple executions (like Controlled Functional Test vs. stand-alone automated replay) of application-specific Stored Procedures.

### SUMMARY

It is the purpose of the present invention to provide an end-to-end method of validating the functionality and performance of a software application that integrates automated regression and performance test phases.

It is another purpose of the present invention to provide a method of validating the functionality and performance of a software application that leverages the automated regression and performance test phases such as to enhance human resource efficiency, reduce testing errors and to produce high quality application software.

It is yet another object of the present invention to provide a testing method that enables the automated regression and performance test phases to be performed concurrently and to produce consistent test results.

1. A system comprised of Microsoft's TSQL Stored Procedures for the automated embedding of Software Snippets into application-specific Microsoft's TSQL Stored Procedures, where:
a. stated herein Software Snippets, activated in automated way during the run-time of the stated herein application-specific Stored Procedures, and having no effect on application software functionality, collect and record to non-volatile storage the stated herein application-specific Stored Procedures' input parameter values and values in all active temporary tables;
b. said designated application-specific Stored Procedures are repetitively executed, in automated way, on said herein collected values, where results of execution are predetermined, or identical, to results obtained during the initial execution of said designated application-specific Stored Procedures.

2. A system as recited in claim 1, further comprised of additional Microsoft's TSQL Stored Procedures for the automated generation of UPDATE, DELETE and INSERT triggers on designated permanent tables, where:
a. each application-relevant permanent table contains IDENTITY and/or TIMESTAMP columns;
b. said herein triggers, in automated way, collect and record to non-volatile storage all changes made to said designated database tables;
c. said designated database tables are restored, in automated way, to values existed prior to the conducting the test;
d. designated application-specific Stored Procedures stated in claim 1 are repetitively executed, in a stand-alone mode and in automated way, thus constituting the automated regression tests of said herein application-specific Stored Procedures on values as stated in claim 1, where functionally-relevant results of execution are:
identical to results obtained during the initial execution of said designated application-specific Stored Procedures; or:
predetermined based on results obtained during the initial execution of said designated application-specific Stored Procedures.

3. A system as recited in claim 2, further comprised of additional Microsoft's TSQL Stored Procedures for the automated generation of UPDATE, DELETE and INSERT triggers on designated permanent tables, where:
a. each application-relevant permanent table contains IDENTITY and/or TIMESTAMP columns;
b. said herein triggers, in automated way, collect and record to non-volatile storage all changes made to said designated database tables;
c. said designated database tables are restored, in automated way, to values existed prior to the conducting the test;
d. designated application-specific Stored Procedures stated in claim 1, modified according to specific needs during said software life cycle, are repetitively executed, in a stand-alone mode and in automated way, on values collected as stated in claim 1, with functionally-relevant results of execution being predetermined from, the results obtained during the initial execution of said designated application-specific Stored Procedures; thus providing the automated consistent test-bed environment for the said software life cycle.

4. A system as recited in claim 3, further comprised of additional Microsoft's TSQL Stored Procedures for the automated generation of UPDATE, DELETE and INSERT triggers on designated permanent tables, where:
a. each application-relevant permanent table contains IDENTITY and/or TIMESTAMP columns;
b. said herein triggers, in automated way, collect and record to non-volatile storage all changes made to said designated database tables;
c. said designated database tables are restored, in automated way, to values existed prior to the conducting the test;
d. designated application-specific Stored Procedures stated in claim 1 are repetitively executed, in a stand-alone mode and in automated way;
e. INSERT and DELETE triggers are modified to substitute plain INSERT functionality with INDENTITY INSERT functionality;
f. functionally-relevant results obtained during said herein executions, in a stand-alone mode and in automated way, are identical, or predetermined, to the results of the initial execution of said designated application-specific Stored Procedures; thus constituting the automated regression tests of said herein application-specific Stored Procedures.

5. A system as recited in claim 4, further comprised of additional Microsoft's TSQL Stored Procedures for the automated generation of reports comparing results obtained during multiple executions of non-modified and/or modified versions of application-specific Stored Procedures.

6. A system comprised of Microsoft's TSQL Stored Procedures for the automated embedding of Software Snippets into designated application-specific Microsoft's TSQL Stored Procedures, where stated herein designated application-specific Stored Procedures are upgraded, in automated way, with BEGIN TRY . . . END TRY BEGIN CATCH . . . END CATCH statements for the purpose of creating a system-wide complete, defect-free and uniform error handling software.

7. A method for the automated embedding of Software Snippets into designated application-specific software functions, where said snippets, during the run-time in automated way, collect the said functions' input parameter values.

8. A method as recited in claim 7, where stated in claim 7 Non-Modified designated application-specific software functions are repetitively executed, in a stand-alone mode and in automated way, on stated in claim 7 collected input values, where functionally-relevant results of execution are predetermined based on results obtained during the initial execution of said designated application-specific software functions.

9. A method as recited in claim 8, where stated in claim 8 designated application-specific software functions, modified according to specific needs during software life cycle, are repetitively executed, in a stand-alone mode and in automated way, on stated in claim 8 collected input values, where functionally-relevant results of execution are predetermined based on results obtained during the initial execution of said designated application-specific software functions and modifications implemented for said software functions.
